(19) United States
(12) Patent Application Publication
(10) Pub. No.: US 2026/0039657 A1
(43) Pub. Date: Feb. 5, 2026

(54) SYSTEM AND METHOD FOR MULTI-FACTOR AUTHENTICATION USING BIOMETRIC IDENTIFICATION

(71) Applicant: QUALCOMM Incorporated, San Diego, CA (US)

(72) Inventors: Ketal GANDHI, San Diego, CA (US); Archana SHRIVASTAVA, San Diego, CA (US); Shenbo YU, Andover, MA (US); Anil Kumar VUTUKURU, San Diego, CA (US); Mandyam VIKRAM, San Diego, CA (US)

(21) Appl. No.: 19/234,073

(22) Filed: Jun. 10, 2025

Related U.S. Application Data
(60) Provisional application No. 63/679,547, filed on Aug. 5, 2024.

(51) Int. Cl. H04L 9/40

(52) U.S. Cl. CPC H04L 63/0861; H04L 63/0807

(57) ABSTRACT

Disclosed are techniques for authentication. In some aspects, an authentication device may receive, from a user device, an identification token of a user attempting to access a secure service. The authentication device may obtain, from a biometric service, a verification status of the user based at least in part on the identification token. The authentication device may determine whether the user is authenticated based at least in part on the verification status. The authentication device may approve access to the secure service based on a determination that the user is authenticated.

### CROSS-REFERENCE TO RELATED APPLICATIONS

The present Application for Patent claims the benefit of U.S. Provisional Application No. 63/679,547, entitled “SYSTEM AND METHOD FOR MULTI-FACTOR AUTHENTICATION USING BIOMETRIC IDENTIFICATION,” filed Aug. 5, 2024, assigned to the assignee hereof, and expressly incorporated herein by reference in its entirety.

### TECHNICAL FIELD

Aspects of the disclosure relate generally to authentication technologies.

### BACKGROUND

Multi-factor authentication (MFA) is a multi-layered security process that grants users access to a network, system, or application only after confirming their identities with more than one credential or authentication factor. MFA may typically involve a combination of a username, a password, and another factor, such as a verification code delivered via text or email, a security token from an authenticator application, or a biometric identifier. MFA have been used to help prevent fraud associated with banking, payment and other transactions.

While some existing biometric authentication techniques may offer significant benefits for security and user convenience, there may be some false acceptance and/or rejection rates as those techniques may rely on one-to-many (1:M) matching, which may be very time consuming, especially when dealing with large databases of biometric templates.

Some existing centralized or cloud-based authentication systems may require users to provide a unique user identification (ID) before the actual biometric matching may take place. Although such systems may provide one-to-one (1:1) matching, they may not be very user-friendly, as users may need to provide their credentials manually before biometric matching.

Existing commercial payment systems may typically only support one or two factor authentication.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method of authentication performed at an authentication device includes receiving, from a user device, an identification token of a user attempting to access a secure service; obtaining, from a biometric service, a verification status of the user based at least in part on the identification token; determining whether the user is authenticated based at least in part on the verification status; and approving access to the secure service based on a determination that the user is authenticated.

In some aspects, an authentication device includes one or more memories; one or more transceivers; and one or more processors communicatively coupled to the one or more memories and the one or more transceivers, the one or more processors, either alone or in combination, configured to: receive, via the one or more transceivers, from a user device, an identification token of a user attempting to access a secure service; obtain, from a biometric service, a verification status of the user based at least in part on the identification token; determine whether the user is authenticated based at least in part on the verification status; and approve access to the secure service based on a determination that the user is authenticated.

In some aspects, an authentication device includes means for receiving, from a user device, an identification token of a user attempting to access a secure service; means for obtaining, from a biometric service, a verification status of the user based at least in part on the identification token; means for determining whether the user is authenticated based at least in part on the verification status; and means for approving access to the secure service based on a determination that the user is authenticated.

In some aspects, a non-transitory computer-readable medium stores computer-executable instructions that, when executed by an authentication device, cause the authentication device to: receive, from a user device, an identification token of a user attempting to access a secure service; obtain, from a biometric service, a verification status of the user based at least in part on the identification token; determine whether the user is authenticated based at least in part on the verification status; and approve access to the secure service based on a determination that the user is authenticated.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example environment for a secure data transaction, according to aspects of the disclosure.

FIG. 2 illustrates an example processing device architecture, according to various aspects of the disclosure.

FIG. 3 illustrates an example system for user authentication, according to aspects of the disclosure.

FIG. 4 illustrates an example of authentication, according to aspects of the disclosure.

FIG. 5 illustrates an example authentication flow, according to aspects of the disclosure.

FIG. 6 illustrates an example authentication flow, according to aspects of the disclosure.

FIG. 7 illustrates an example authentication flow, according to aspects of the disclosure.

FIG. 8 illustrates an example of authentication, according to aspects of the disclosure.

FIG. 9 illustrates an example authentication flow, according to aspects of the disclosure.

FIG. 10 illustrates an example authentication flow, according to aspects of the disclosure.

FIG. 11 illustrates an example method of authentication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to authentication. Some aspects more specifically relate to multi-factor authentication (MFA). In some examples, authentication may be performed at authentication device which receives one or more identification tokens from one or more user devices in proximity to the authentication device, communicates with a biometric service to obtain a verification status of each of the users, and approves or denies a request for secure access by each of the users.

Particular aspects of the subject matter described in this disclosure can be implemented to realize one or more of the following potential advantages. In some examples, by performing authentication operations for one or more users at authentication device, the described techniques can be used to enhance the efficiency and reduce the latency of authentication operations while improving user experience.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation cNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

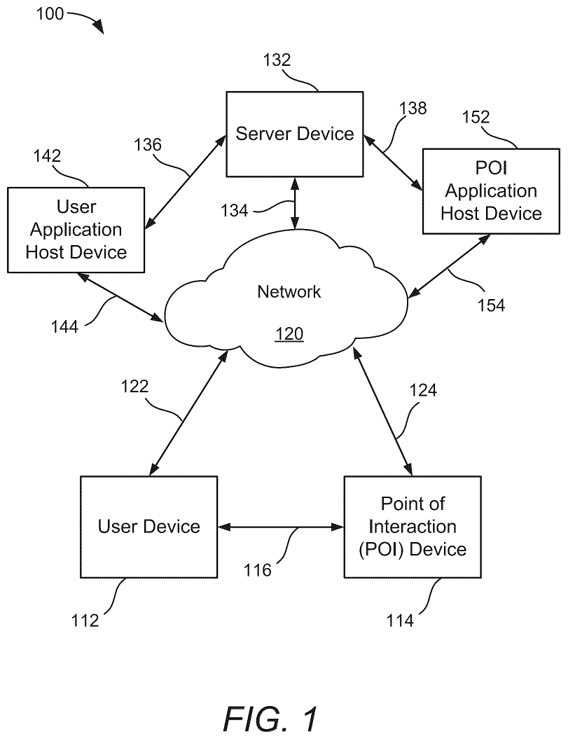

FIG. 1 illustrates an example environment 100 for a secure data transaction, according to aspects of the disclosure. In some aspects, various devices or components in the environment 100 may be configured to communicate based on wired communication systems and/or wireless communication systems.

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

Moreover, a fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements.

Also, there are other wireless communication systems developed for communications with an effective range shorter than that of the aforementioned wireless communication systems (e.g., LTE, WiMax, or 5G). The other wireless communication systems for short-range communications may be based on a radio access technology (RAT) such as WiFi, LTE-D, Bluetooth®, Zigbee®, Z-Wave®, sidelink (e.g., PC5 interface) based on LTE or 5G, dedicated short-range communications (DSRC), wireless access for vehicular environments (WAVE), near-field communication (NFC), ultra-wideband (UWB), Bluetooth® low energy (BLE), etc. In some aspects, these other wireless communication systems for short-range communications may be designed to provide data communications as well as positioning or ranging services.

As shown in FIG. 1, the environment 100 may include a user device 112 and a point of interaction (POI) device 114. In some aspects, the user device 112 may be a mobile device or a user equipment (UE). In some aspects, the POI device 114 may be an internet of things (IOT) device. In some aspects, the user device 112 and the POI device 114 may be configured to communicate with each other via device-to-device (D2D) communications 116 based on any short-range, mid-range, and/or long-range communication technologies (e.g., sidelink, WiFi, UWB, NFC, Bluetooth®, BLE, or the like). In some aspects, the user device 112 may be communicatively coupled to a network 120 via communications 122 based on a wireless communication technology, such as any of the wireless communication technologies discussed above. In some aspects, the POI device 114 may be communicatively coupled to the network 120 via communications 124 based on a wired communication technology or a wireless communication technology.

As shown in FIG. 1, the environment 100 may include a server device 132 that may be communicatively coupled to the network 120 via communications 134 based on a wired communication technology or a wireless communication technology. The environment 100 may include a user application host device 142 that may be communicatively coupled to the network 120 via communications 144 based on a wired communication technology or a wireless communication technology. The environment 100 may include a POI application host device 152 that may be communicatively coupled to the network 120 via communications 154 based on a wired communication technology or a wireless communication technology. In some aspects, the server device 132 may be, in addition to or in place of passing through the network 120, communicatively coupled to the user application host device 142 via communications 136 based on a wired communication technology or a wireless communication technology. In some aspects, the server device 132 may be, in addition to or in place of passing through the network 120, communicatively coupled to the POI application host device 152 via communications 138 based on a wired communication technology or a wireless communication technology.

In some aspects, the environment 100 is depicted as a simplified, non-limiting example. In some aspects, some components may be simplified or not depicted in FIG. 1. For example, in some aspects, the server device 132 may be implemented as one or more physical devices. In some aspects, the user application host device 142 may be implemented as one or more physical devices or may be, in whole or in part, incorporated into the server device 132. In some aspects, the POI application host device 152 may implemented as one or more physical devices or may be, in whole or in part, incorporated into the server device 132.

In some aspects, the user device 112 may engage in a secure data transaction session with the POI device 114 in order to send transaction data to the POI device 114. In some aspects, the user device 112 may engage in the secure data transaction session based on operating an application obtained from and/or managed by the user application host device 142. In some aspects, the transaction data may be sent to the POI device 114 based on the device-to-device communications 116, or the POI device 114 scanning a visual image (e.g., a barcode or a two-dimensional data code) displayed by the user device 112, or a combination thereof. In some aspects, the POI device 114 may engage in the secure data transaction session based on operating an application obtained from and/or managed by the POI application host device 152. In some aspects, the transaction data may be forwarded to the server device 132 for further processing and/or verification.

In some aspects, the environment 100 may be used to allow the user device 112 to make a payment to the POI device 114 based on the transaction data sent using the secure data transaction session. In some aspects, the environment 100 may correspond to an implementation example of a contactless payment system or a touchless payment system.

In some aspects, in order to better identifying and/or preventing possible fraudulent activities, a payment system as discussed in this disclosure may be based on indoor location data of the user device 112 (e.g., obtained based on a positioning service according to the example wireless communication systems discussed above). In some aspects, geolocation data of the user device 112 based on a global navigation satellite system (GNSS) may not be sufficiently accurate for indoor shopping. In some aspects, making a payment using a payment system as discussed in this disclosure may be based on a secure data transaction session triggered by the indoor location data of the user device 112 satisfying certain criteria. In some aspects, NFC may be used when the user device 112 is very close to the POI device 114, but NFC may not be capable of providing more secure data communications.

In some aspects, various embodiments described in this disclosure may correspond to initiating the data transaction and/or device authentications based on the indoor location information of the user device 112 indicating that the user device 112 is in close proximity to the POI device 114. In some aspects, various embodiments described in this disclosure may provide proximity detection at the user device 112 for automated processing to increase convenience for the users. In some aspects, the payload data from the POT device 114 may also be used for determining the location of the user device 112.

In some aspects, the user device 112 and the POI device 114 may establish D2D communications 116 based on communication technologies such as BLE, UWB, or cellular communication for a secure data transaction. In some aspects, a cryptographic method with a mutual authentication procedure may be applied to avoid vulnerabilities such as spoofing, eavesdropping, jamming, and/or relay attacks. In some aspects, the POI device 114 may send encrypted advertisements with hardware keys, which may be provisioned and/or rotated by the server device 132 (e.g., as a cloud service). In some aspects, the user device 112 and the POI device 114 may undergo periodic attestation using an attestation microservice to enhance fraud protection.

In some aspects, the D2D communications 116 according to this disclosure may correspond to short-range, mid-range, or long-range communications such that the user of the user device 112 may engage in the secure data transaction session without staying in a long queue. In some aspects, multiple user devices may communicate with one POI device or engage in peer-to-peer communications.

In some aspects, the POI device 114 according to this disclosure may integrate other types of payment system, such as an image-based payment system (e.g., based on scanning a barcode or a two-dimensional data code), to further enhance security and/or reduce overall costs.

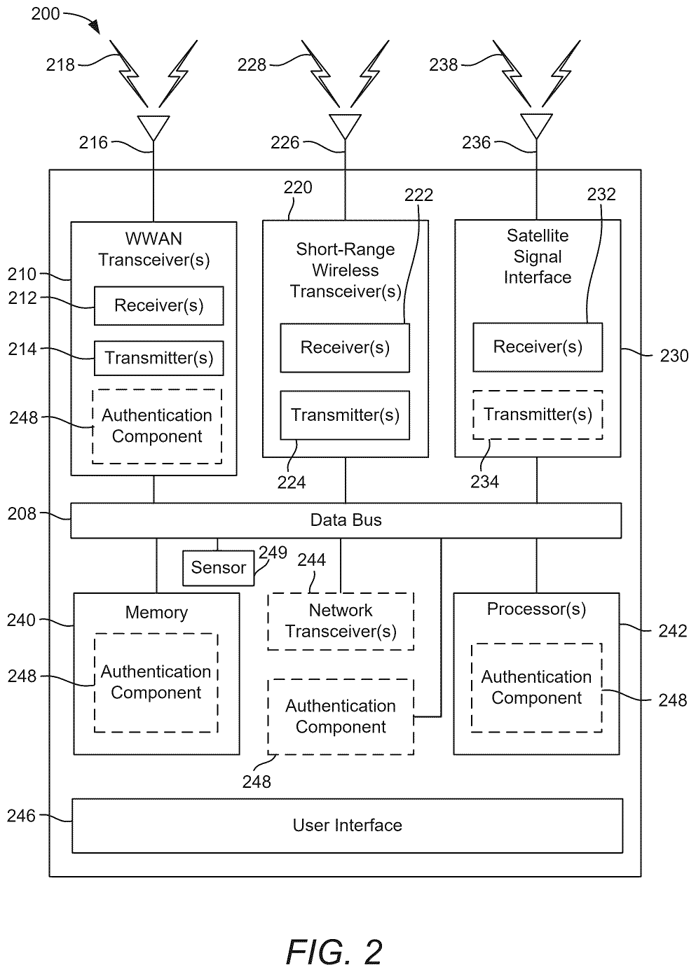

FIG. 2 illustrates several example components (represented by corresponding blocks) that may be incorporated into a processing device 200 (which may correspond to the user device 112 or the POI device 114 described herein). It will be appreciated that these components may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The processing device 200 includes one or more wireless wide area network (WWAN) transceivers 210 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 210 may each be connected to one or more antennas 216 for communicating with other network nodes, such as other processing devices, UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 210 may be variously configured for transmitting and encoding signals 218 (e.g., messages, indications, information, and so on) and, conversely, for receiving and decoding signals 218 (e.g., messages, indications, information, pilots, and so on) in accordance with the designated RAT. Specifically, the one or more WWAN transceivers 210 include one or more transmitters 214 for transmitting and encoding signals 218 and one or more receivers 212 for receiving and decoding signals 218.

The processing device 200 also includes, at least in some cases, one or more short-range wireless transceivers 220. The one or more short-range wireless transceivers 220 may be connected to one or more antennas 226 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, BLUETOOTH®, ZIGBEE®, Z-WAVE®, PC5, dedicated short-range communications (DSRC), wireless access for vehicular environments (WAVE), NFC, UWB, etc.) over a wireless communication medium of interest. The one or more short-range wireless transceivers 220 may be variously configured for transmitting and encoding signals 228 (e.g., messages, indications, information, and so on) and, conversely, for receiving and decoding signals 228 (e.g., messages, indications, information, pilots, and so on) in accordance with the designated RAT. Specifically, the one or more short-range wireless transceivers 220 include one or more transmitters 224 for transmitting and encoding signals 228 and one or more receivers 222 for receiving and decoding signals 228. As specific examples, the one or more short-range wireless transceivers 220 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The processing device 200 also includes, at least in some cases, a satellite signal interface 230, which includes one or more satellite signal receivers 232 and may optionally include one or more satellite signal transmitters 234. The one or more satellite signal receivers 232 may be connected to one or more antennas 236 and may provide means for receiving and/or measuring satellite positioning/communication signals 238. Where the one or more satellite signal receivers 232 include a satellite positioning system receiver, the satellite positioning/communication signals 238 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 232 include a non-terrestrial network (NTN) receiver, the satellite positioning/communication signals 238 may be communication signals (e.g., carrying control and/or user data) originating from a 5G network. The one or more satellite signal receivers 232 may comprise any suitable hardware and/or for software receiving and processing satellite positioning/communication signals 238. The one or more satellite signal receivers 232 may request information and operations as appropriate from the other systems, and, at least in some cases, perform calculations to determine locations of the processing device 200 using measurements obtained by any suitable satellite positioning system algorithm.

The optional satellite signal transmitter(s) 234, when present, may be connected to the one or more antennas 236 and may provide means for transmitting satellite positioning/communication signals 238. Where the one or more satellite signal transmitters 234 include an NTN transmitter, the satellite positioning/communication signals 238 may be communication signals (e.g., carrying control and/or user data) originating from a 5G network. The one or more satellite signal transmitters 234 may comprise any suitable hardware and/or software for transmitting satellite positioning/communication signals 238. The one or more satellite signal transmitters 234 may request information and operations as appropriate from the other systems.

The processing device 200 may include one or more network transceivers 244, providing means for communicating (e.g., means for transmitting, means for receiving, etc.) with other entities. For example, the processing device 200 may employ the one or more network transceivers 244 to communicate with other processing devices over one or more wired or wireless links.

A transceiver may be configured to communicate over a wired or wireless link. A transceiver (whether a wired transceiver or a wireless transceiver) includes transmitter circuitry (e.g., transmitters 214, 224) and receiver circuitry (e.g., receivers 212, 222). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 214, 224) may include or be coupled to a plurality of antennas (e.g., antennas 216, 226), such as an antenna array, that permits the respective apparatus (e.g., processing device 200) to perform transmit “beamforming,” as described herein. Similarly, wireless receiver circuitry (e.g., receivers 212, 222) may include or be coupled to a plurality of antennas (e.g., antennas 216, 226), such as an antenna array, that permits the respective apparatus (e.g., processing device 200) to perform receive beamforming, as described herein. In some aspects, the transmitter circuitry and receiver circuitry may share the same plurality of antennas (e.g., antennas 216, 226), such that the respective apparatus can only receive or transmit at a given time, not both at the same time. A wireless transceiver (e.g., the one or more WWAN transceivers 210, the one or more short-range wireless transceivers 220) may also include a network listen module (NLM) or the like for performing various measurements.

As used herein, the various wireless transceivers (e.g., transceivers 210 and 220, and network transceivers 244 in some implementations) and wired transceivers (e.g., network transceivers 244 in some implementations) may generally be characterized as “a transceiver,” “at least one transceiver,” or “one or more transceivers.” As such, whether a particular transceiver is a wired or wireless transceiver may be inferred from the type of communication performed.

The processing device 200 also includes other components that may be used in conjunction with the operations as disclosed herein. The processing device 200 includes one or more processors 242 for providing functionality relating to, for example, wireless communication, and for providing other processing functionality. The one or more processors 242 may therefore provide means for processing, such as means for determining, means for calculating, means for receiving, means for transmitting, means for indicating, etc. In some aspects, the one or more processors 242 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The processing device 200 includes memory circuitry implementing memory 240 (e.g., each including a memory device) for maintaining information (e.g., information indicative of reserved resources, thresholds, parameters, and so on). The memory 240 may therefore provide means for storing, means for retrieving, means for maintaining, etc. In some cases, the processing device 200 may include an authentication component 248. The authentication component 248 may be hardware circuits that are part of or coupled to the one or more processors 242 that, when executed, cause the processing device 200 to perform the functionality described herein. In other aspects, the authentication component 248 may be external to the processors 242 (e.g., part of a modem processing system, integrated with another processing system, etc.).

Alternatively, the authentication component 248 may be a memory module stored in the memory 240 that, when executed by the one or more processors 242 (or a modem processing system, another processing system, etc.), cause the processing device 200 to perform the functionality described herein. FIG. 2 illustrates possible locations of the authentication component 248, which may be, for example, part of the one or more WWAN transceivers 210, the memory 240, the one or more processors 242, or any combination thereof, or may be a standalone component.

The various components of the processing device 200 may be communicatively coupled to each other over a data bus 208. In some aspects, the data bus 208 may form, or be part of, a communication interface of the processing device 200.

In addition, the processing device 200 may include a user interface 246 providing means for providing indications (e.g., audible and/or visual indications) to a user and/or for receiving user input (e.g., upon user actuation of a sensing device such a keypad, a touch screen, a microphone, and so on).

For convenience, the processing device 200 is shown in FIG. 2 as including various components that may be configured according to the various examples described herein. It will be appreciated, however, that the illustrated components may have different functionality in different designs. In particular, various components in FIG. 2 are optional in alternative configurations and the various aspects include configurations that may vary due to design choice, costs, use of the device, or other considerations. In one example, a particular implementation of processing device 200 configured as a user device (e.g., the user device 112) may omit the one or more network transceivers 244, or may omit the satellite signal interface 230, and so on. In another example, a particular implementation of processing device 200 configured as a POI device (e.g., the POI device 114) may omit the WWAN transceiver(s) 210, or may omit the satellite signal interface 230, and so on. For brevity, illustration of the various alternative configurations is not provided herein, but would be readily understandable to one skilled in the art.

The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 210 to 246 may be implemented by processor and memory component(s) of the processing device 200 (e.g., by execution of appropriate code and/or by appropriate configuration of processor components). For simplicity, various operations, acts, and/or functions are described herein as being performed “by a processing device,” “by a user device,” and/or “by a POI device.” However, as will be appreciated, such operations, acts, and/or functions may actually be performed by specific components or combinations of components of the processing device 200, such as the one or more processors 242, the one or more transceivers 210, 220 and/or 244, the memory 240, the authentication component 248, etc. In some aspects, a sensor 249 (e.g., a biometric sensor) may be implemented to read sensor data of a user, for example.

In some aspects, methods and apparatus for user-friendly multi-factor authentication (MFA) are provided for secure access control, for example, for banking transactions, payments, employment applications, transactions with the government, or other transactions requiring user privacy. In addition to these transactions, MFA may also be applicable in various other scenarios, for example, entry into a secured area such as an auditorium entry or an office building.

In some implementations, MFA may be used for ensuring that only the user with the correct credentials may access a system, by using a consumer application, an IoT application, a biometric reader application, or any combination thereof. In some implementations, the consumer application may reside in a user device (i.e., a mobile device or UE). In some implementations, the IoT application and/or the biometric reader application may reside in a terminal device (e.g., a merchant terminal that may be wired or wireless). Some of the applications may reside in separate devices or integrated in a single device according to aspects of the disclosure.

In some implementations, device-to-device communications between the user device and the terminal device (e.g., where the IoT application and/or the biometric reader application resides) may be based on a short-range communication protocol, such as Wi-Fi (direct), BLUETOOTH®, or BLUETOOTH® Low Energy (BLE). Ultra-wideband (UWB) may also be used for device-to-device communications. In some implementations, a cellular based communications network (e.g., 5G, 5G+, 6G) or a private network with a sidelink may be used for device-to-device communications.

In some aspects, MFA systems and methods are provided that take into account various factors, including, for example, who the users are (e.g., using biometrics such as fingerprints, palmprints, face recognition, voice, heartbeat, iris, etc.), where they are (e.g., based on the locations of user devices), what they do (e.g., analyzing their traveling behavior pattern such as location and time), and what they possess (e.g., types of user devices such as mobile devices).

In some aspects, a terminal device may communicate with one or more user devices and perform authentication of one or more users by incorporating one-to-one (1:1) matching, one-to-multiple matching, or both, within its authentication component that includes biometric matching. In some aspects, the one-to-multiple matching may include one-to-few (1:F) matching (where F is usually less than 5 and represents the number of device-to-device connections).

In case 1:1 matching or 1:F matching fails, one-to-many (1:M) matching may be performed by using a larger number of candidates retrieved from a biometric service (e.g., a biometric cloud or database). By performing 1:1 matching or 1:F matching before 1:M matching is attempted, the efficiency of authentication operations may be improved while latency may be reduced, thus providing an improved overall user experience.

In some aspects, when a user device (e.g., a mobile device) is near a biometric reader, it may transmit a biometric data template of the user as a token to a biometric reader in the terminal device through a mutually authenticated secure channel. Subsequently, this biometric data template may be used for a 1:1 matching process. In some aspects, the token may be encrypted or plain data.

In some aspects, in addition or as an alternative to the biometric data template, a user device may transmit its username or credentials as a token to the biometric reader. Subsequently, the username or credentials may serve as an index to retrieve the biometric data of the user for matching purposes. This process may also fall under the category of 1:1 matching.

In some aspects, when two or more users are in proximity to a terminal device which includes a biometric reader, multiple user devices may transmit biometric data templates as tokens to the biometric reader via secure channels for 1:F matching of biometric readings of multiple users.

In some aspects, multiple user devices may transmit user credentials of multiple users as tokens to the biometric reader. In some aspects, a list of user IDs associated with these credentials may then be used to retrieve a corresponding list of biometric data templates for 1:F matching of biometric readings.

In some aspects, by allowing a terminal device to process authentication requests from one or more users with user devices in proximity to the terminal device, the authentication process may be touchless and user-friendly from the user standpoint, thus improving user experience.

In some aspects, within the terminal device, a watch list of potential users may be generated dynamically when user devices are within proximity of the terminal device. For example, where the terminal device includes an Internet of Things (IOT) application with a BLUETOOTH® or BLUETOOTH® Low Energy (BLE) communication function, when a user device enters a location geofence or geographical proximity of the terminal device, the terminal device may establish a BLUETOOTH® or BLE connection with the user device to allow the user device to send its user ID to the terminal device.

In some aspects, in cases where 1:1 or 1:F matching fails, metadata such as device ID, location, and/or time may be utilized to narrow down the list of candidates retrieved from biometric cloud or databases. In some aspects, 1:M matching may be performed if 1:1 or 1:F matching fails (where M>F), thus ensuring reliable and accurate authentication of the user. In some aspects, appropriate factors based on context and availability may be used for biometric matching. For example, in addition to the device ID, location, and/or time, the type of user device, the characteristics of the user device, the usage pattern of the user device based on a behavior pattern of the user, and/or other factors may be considered for narrowing down the list of candidates for user identification. In some aspects, the identification token may include a biometric data template of the user, a user name, one or more user credentials, a location of the user, a behavior pattern of the user, or any combination thereof.

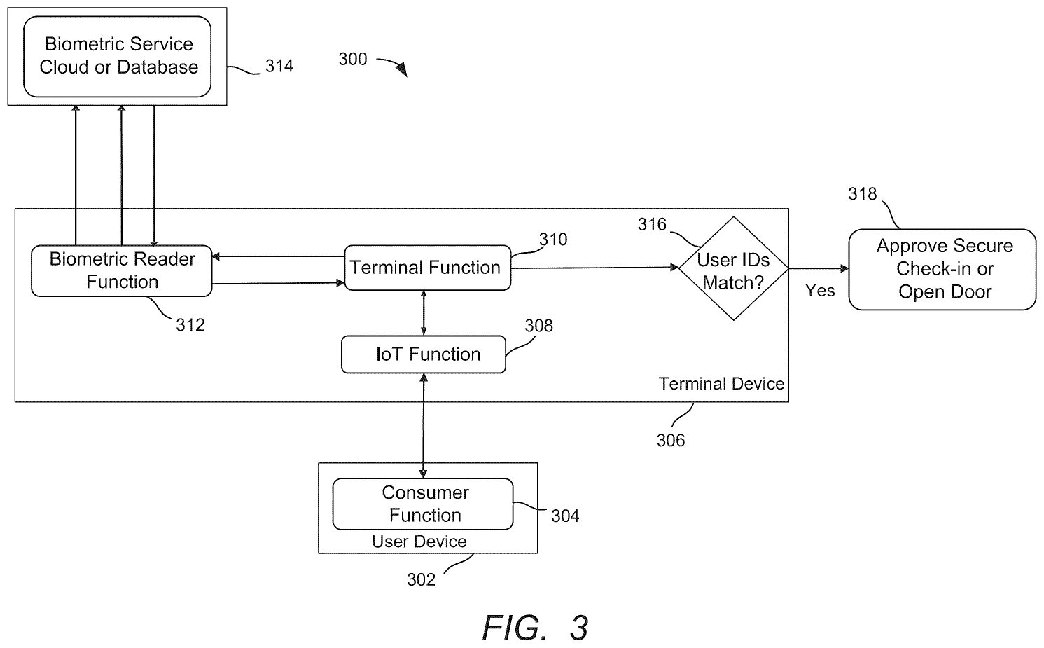

FIG. 3 illustrates an example system 300 for user authentication, according to aspects of the disclosure. In the example illustrated in FIG. 3, a user device 302 (e.g., a mobile device) may be a device that is owned, possessed, or directly accessible by a user. In some aspects, the user device 302 may have a consumer function 304 (e.g., a consumer application or software development kit (SDK)) installed thereon. In some aspects, the consumer function 304 may provide an application programming interface (API) to allow the user device 302 to communicate with another device, such as a terminal device 306, as shown in FIG. 3.

In the example shown in FIG. 3, the terminal device 306 includes an IoT function 308 (e.g., an IoT application), a terminal function 310 (e.g., a terminal application), and a biometric reader function 312 (e.g., a biometric reader application). In some aspects, the IoT function 308 may perform bidirectional communication operations with the user device 302 via a communication link, for example, a short-range communication link such as a BLUETOOTH® or BLE communication link, a Wi-Fi communication link such as an enterprise Wi-Fi link with encryption, or an ultra-wideband (UWB) communication link. When the user device 302 is in proximity (e.g., a relatively short distance) to the terminal device 306, the user device 302 may send its user ID to the IoT function 308 to allow the terminal device 306 to detect the presence of the user device 302.

In some aspects, the terminal device 306 may communicate with the user device 302 via a longer-range communication link such as a cellular or WWAN link, for example. In some implementations, the terminal device 306 may not include an IoT function and may instead communicate with the user device 302 through another communication function. Communications between the user device 302 and the terminal device 306 may be established and maintained in various manners according to aspects of the disclosure.

In some aspects, if the biometric data of a user has not yet been entered into a biometric cloud or database, the user may use the user device 302 and the terminal device 306 to perform biometric enrollment. For example, the user may scan his or her biometrics (e.g., fingerprint(s), palmprint(s), face, retina, etc.) on the biometric reader function 312 and enter his or her user ID (e.g., email address, cell phone number, etc.) on the user device 302. User data including the biometrics and user ID may be sent by the biometric reader function 312 on the terminal device 306 to a biometric service cloud or database 314 for user enrollment. The biometric service cloud or database 314 may then generate a biometric ID mapped to the user ID associated with the user.

In some aspects, authentication processes may be performed by the system 300 including the terminal device 306 and the biometric service cloud or database 314, according to aspects of the disclosure. For example, when the user enters an IoT location geofence, the user device 302 may scan for IoT devices. When the user device 302 is within an area of proximity to the terminal device 306 that is equipped with an IoT function, for example, the user device 302 may send its user ID to the IoT function 308 of the terminal device 306.

In some aspects, upon receiving the user ID from the user device 302, the IoT function 308 may send a user ID list (which presumably may include the user ID associated with the user device 302) to the terminal function 310 of the terminal device 306. The terminal function 310 may then send the user ID list and metadata (e.g., device ID, location, and/or time) to the biometric reader function 312 of the terminal device 306.

In some aspects, the biometric reader function 312 may read biometric data of the user from the terminal function 310 and submit the biometric data, user ID, and/or metadata to the biometric service cloud or database 314. In some aspects, the biometric service cloud or database 314 may return a verification status for the user to the biometric reader function 312. In some aspects, a user's biometric data may be read by the biometric reader function 312 at the terminal device 306. Alternatively or additionally, the user's biometric data may be read by another device, such as the user device 302 (if it is equipped with a biometric reader function), or a separate device (not shown in FIG. 3) according to aspects of the disclosure.

Upon receiving the user verification status from the biometric service cloud or database 314, the biometric reader function 312 may send its matched result to the terminal function 310. The terminal function 310 may determine whether the user is authenticated based at least in part on the user verification status received from the biometric service cloud or database 314. Upon making a determination that the user is authenticated by matching the user ID and the biometric data, as indicated by block 316, the terminal device 306 may approve a request for access by the user to a secure service (e.g., banking, sales, payment, etc.). For example, a door to a secure location may be opened (318) or a user may be checked-in, for example to a flight or train at an airport or train station. These are just examples, and other outcomes as a result of authentication may be implemented.

In some aspects, the devices and database illustrated in FIG. 3 may be implemented in a communication network such as the one shown in FIG. 1 described above. For example, the user device 302 of FIG. 3 may be the user device 112 of FIG. 1, the terminal device 306 of FIG. 3 may be the POI device 114 of FIG. 1, and the biometric service cloud or database 314 of FIG. 3 may be implemented in the service device 132 of FIG. 1.

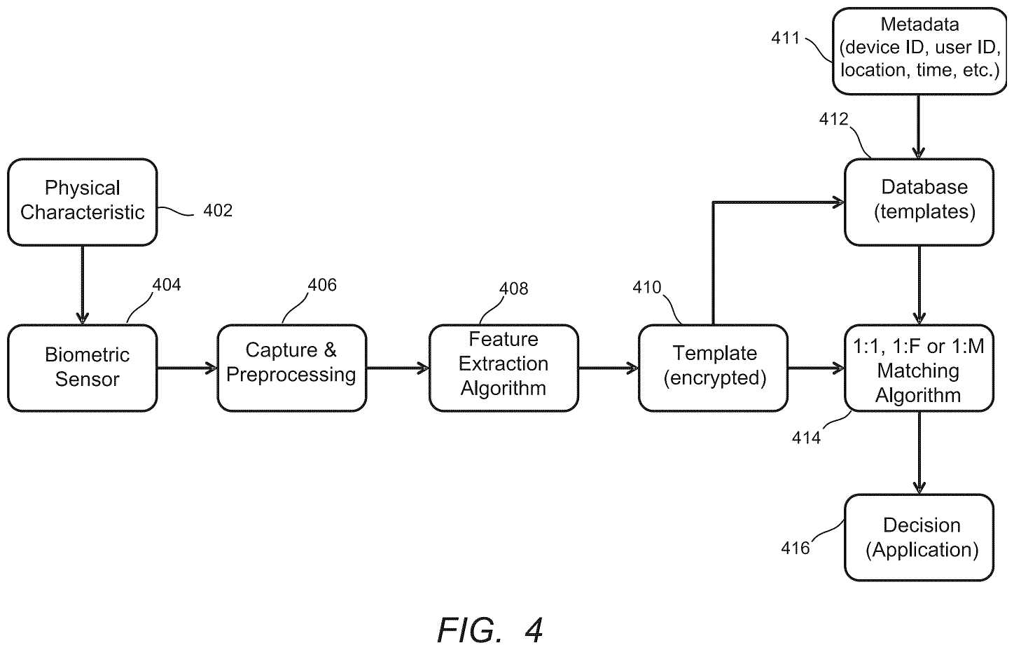

FIG. 4 illustrates an example of authentication, according to aspects of the disclosure. In the example illustrated in FIG. 4, the physical characteristic 402 of a user is read (e.g., scanned) by a biometric sensor 404 to generate raw biometric data. The raw biometric data may be captured and preprocessed in block 406. A feature extraction algorithm 408 may then be applied to the captured and preprocessed biometric data.

After the feature extraction algorithm 408 is applied to the captured and preprocessed biometric data, a biometric data template 410 may be created based on extracted biometric features, for example. In some aspects, the biometric data template may be encrypted for further security. Alternatively, the biometric data template may be unencrypted before it is transmitted to a biometric cloud or database 412 via a secure communication link.

In the example shown in FIG. 4, the encrypted biometric data template 410 is transmitted to the biometric database 412, which may store a plurality of biometric data templates for a plurality of users. In some aspects, in addition to biometric data templates, the biometric database 412 may also store metadata 411 (e.g., device IDs, user IDs, locations, times, etc.) for various users to help further identify the individual users associated with the biometric data templates and metadata.

In the example shown in FIG. 4, a one-to-one (1:1) matching algorithm, a one-to-few (1:F) matching algorithm, and/or a one-to-many (1:M) matching algorithm 414 may be applied to data retrieved from the biometric database 412. After applying the matching algorithm 414, a decision may be made on the request by a user to access a secure service in block 416.

In some implementations, the processes illustrated in FIG. 4 may be performed by one or more components shown in FIG. 2. For example, the biometric sensor 404 in FIG. 4 may be the sensor 249 in the processing device in FIG. 2, and processes including capturing and preprocessing in block 406, feature extraction algorithm in block 408, and creation of biometric data template 410 in FIG. 4 may be performed by the authentication component 248 in FIG. 2.

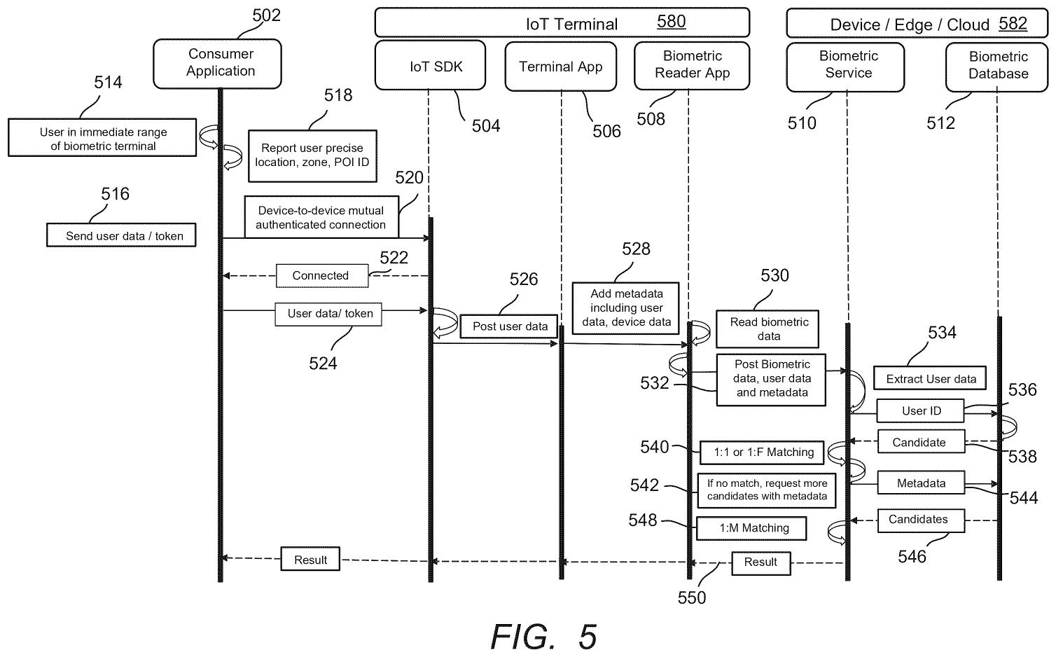

FIG. 5 illustrates an example authentication flow, according to aspects of the disclosure. In the example illustrated in FIG. 5, a consumer application 502 (e.g., at a merchant or point of sale (POS)), an IoT SDK 504, a terminal application 506, a biometric reader application 508, a biometric service 510, and a biometric database 512 are provided. In some aspects, the IoT SDK 504, the terminal application 506 and the biometric reader application 508 may be part of an IoT terminal 580, whereas the biometric service 510 and/or the biometric database 512 may run on a device/edge/cloud 582. For example, in some implementations, the biometric service 510 may run on a device such as the IoT terminal 580.

At stage 514, the user device may be in the immediate range or proximity of a biometric terminal, such as a terminal device with a consumer application 502. At stage 516, the user device may send user data and/or token to the consumer application 502.

At stage 518, additional information such as the precise location of the user device, the zone in which the user device is located, and/or a point of interaction (POI) ID may be reported. At stage 520, a device-to-device mutually authenticated connection may be established between the consumer application 502 and the IoT SDK 504. Once the IoT SDK 504 signals to the consumer application 502 that a connection has been established at stage 522, the consumer application 502 may send the user data and/or token to the IoT SDK 504 at stage 524.

At stage 526, the IoT SDK 504 may post the user ID to the terminal application 506. At stage 528, the terminal application 506 may add metadata including user ID and device data and send the metadata to the biometric reader application 508.

At stage 530, the biometric reader application 508 may read biometric data of the user. At stage 532, the biometric reader application 508 may transmit the biometric data and metadata to the biometric service 510. At stage 534, user data may be extracted from the biometric database 512. At stage 536, the user ID may be sent to the biometric database 512. In response, at stage 538, the biometric database 512 may send one or more candidates of likely users whose biometric data potentially match that of the user seeking authentication.

At stage 540, one-to-one (1:1) or one-to-few (1:F) matching is performed. At stage 542, if no match is found by 1:1 or 1:F matching, then additional candidates may be requested by using metadata for potentially identifying additional candidates. At stage 544, the metadata may be sent to the biometric database 512. In response, at stage 546, the biometric database 512 may send additional candidates to the biometric service 510. At stage 548, one-to-many (1:M) matching is performed. At stage 550, the result of the matching may be transmitted back to the IoT terminal 580 and the consumer application 502.

Although FIG. 5 shows an example process flow of authentication, in some implementations, the process flow may include additional blocks, fewer blocks, different blocks, or differently arranged blocks from those depicted in FIG. 5. Additionally, or alternatively, some of the processes may be performed in parallel, or performed in a sequence different from the sequence listed in FIG. 5.

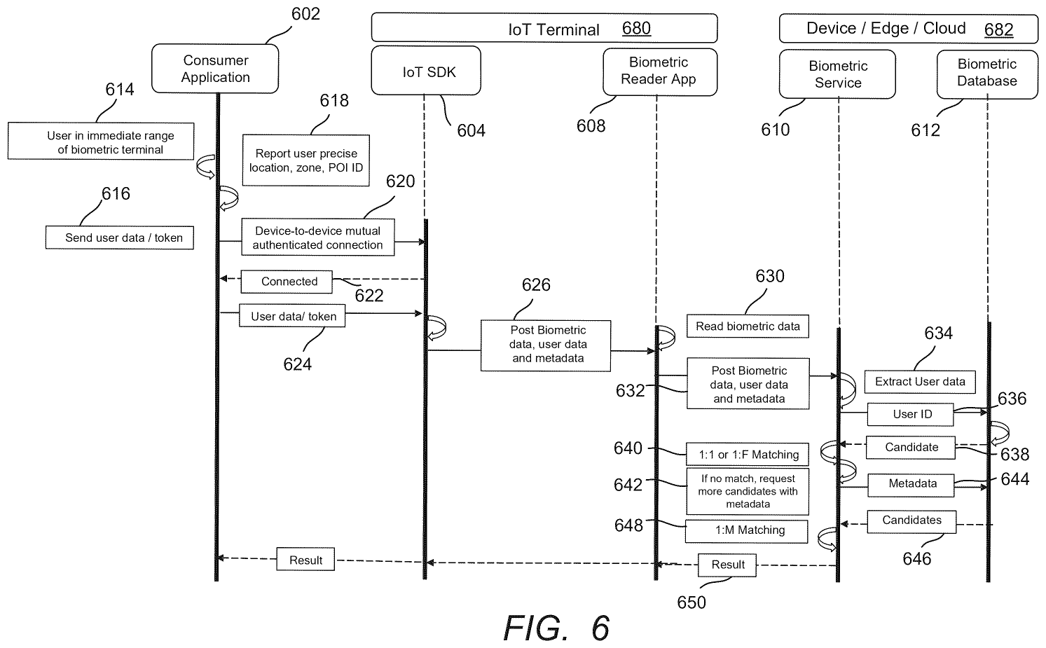

FIG. 6 illustrates an example authentication flow, according to aspects of the disclosure. In the example illustrated in FIG. 6, a consumer application 602 (e.g., installed in a user device), an IoT SDK 604, a biometric reader application 608, a biometric service 610, and a biometric database 612 are provided. In some aspects, the IoT SDK 604 and the biometric reader application 608 may be part of an IoT terminal 680, whereas the biometric service 610 and/or the biometric database 612 may be run on a device/edge/cloud 682. For example, in some implementations, the biometric service 610 may run on a device such as the IoT terminal 680. In the example shown in FIG. 6, there is no terminal application in the IoT terminal 680.

At stage 614, the user device may be in the immediate range or proximity of a biometric terminal, such as a terminal device with a consumer application 602. At stage 616, the user device may send user data and/or token to the consumer application 602.

At stage 618, additional information such as the precise location of the user device, the zone in which the user device is located, and/or a point of interaction (POI) ID may be reported. At stage 620, a device-to-device mutually authenticated connection may be established between the consumer application 602 and the IoT SDK 604. Once the IoT SDK 604 signals to the consumer application 602 that a connection has been established at stage 622, the consumer application 602 may send the user data and/or token to the IoT SDK 604 at stage 624.

At stage 626, the IoT SDK 604 may post the user ID to the biometric reader application 608. At stage 630, the biometric reader application 608 may read biometric data of the user. At stage 632, the biometric reader application 608 may transmit the biometric data and metadata to the biometric service 610. At stage 634, user data may be extracted from the biometric database 612. At stage 636, the user ID may be sent to the biometric database 612. In response, at stage 638, the biometric database 612 may send one or more candidates of likely users whose biometric data potentially match that of the user seeking authentication.

At stage 640, one-to-one (1:1) or one-to-few (1:F) matching is performed. At stage 642, if no match is found by 1:1 or 1:F matching, then additional candidates may be requested by using metadata for potentially identifying additional candidates. At stage 644, the metadata may be sent to the biometric database 612. In response, at stage 646, the biometric database 612 may send additional candidates to the biometric service 610. At stage 648, one-to-many (1:M) matching is performed. At stage 650, the result of the matching may be transmitted back to the IoT terminal 680 and the consumer application 602.

Although FIG. 6 shows an example process flow of authentication, in some implementations, the process flow may include additional blocks, fewer blocks, different blocks, or differently arranged blocks from those depicted in FIG. 6. Additionally, or alternatively, some of the processes may be performed in parallel, or performed in a sequence different from the sequence listed in FIG. 6.

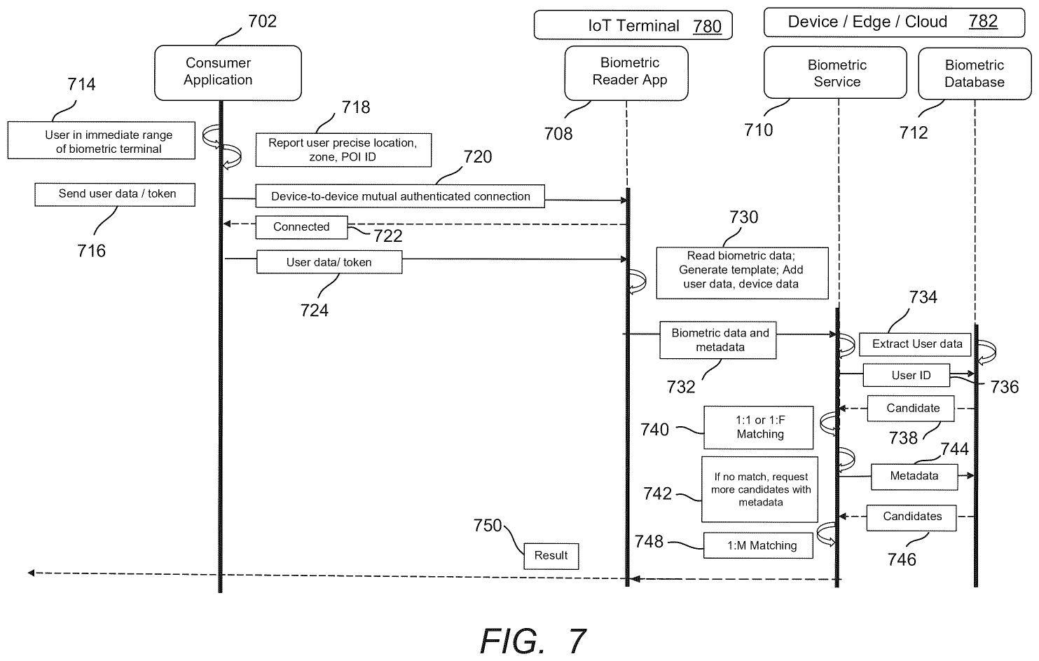

FIG. 7 illustrates an example authentication flow, according to aspects of the disclosure. In the example illustrated in FIG. 7, a consumer application 702 (e.g., installed in a user device), a biometric reader application 708, a biometric service 710, and a biometric database 712 are provided. In some aspects, the biometric reader application 708 may be part of an IoT terminal 780, whereas the biometric service 710 and/or the biometric database 712 may run on a device/edge/cloud 782. For example, in some implementations, the biometric service 710 may run on a device such as the IoT terminal 780. In the example shown in FIG. 7, there is no terminal application in the IoT terminal 780, and the IoT SDK is integrated into the biometric reader application 708.

At stage 714, the user device may be in the immediate range or proximity of a biometric terminal, such as a terminal device with a consumer application 702. At stage 716, the user device may send user data and/or token to the consumer application 702.

At stage 718, additional information such as the precise location of the user device, the zone in which the user device is located, and/or a point of interaction (POI) ID may be reported. At stage 720, a device-to-device mutually authenticated connection may be established between the consumer application 702 and the biometric reader application 708. Once the biometric reader application 708 signals to the consumer application 702 that a connection has been established at stage 722, the consumer application 702 may send the user data and/or token to the biometric reader application 708 at stage 724.

At stage 730, the biometric reader application 708 may read biometric data of the user, generate a biometric data template, and add user data and/or device data. At stage 732, the biometric reader application 708 may transmit the biometric data and metadata to the biometric service 710. At stage 734, user data may be extracted from the biometric database 712. At stage 736, the user ID may be sent to the biometric database 712. In response, at stage 738, the biometric database 712 may send one or more candidates of likely users whose biometric data potentially match that of the user seeking authentication.

At stage 740, one-to-one (1:1) or one-to-few (1:F) matching is performed. At stage 742, if no match is found by 1:1 or 1:F matching, then additional candidates may be requested by using metadata for potentially identifying additional candidates. At stage 744, the metadata may be sent to the biometric database 712. In response, at stage 746, the biometric database 712 may send additional candidates to the biometric service 710. At stage 748, one-to-many (1:M) matching is performed. At stage 750, the result of the matching may be transmitted back to the IoT terminal 780 and the consumer application 702.

Although FIG. 7 shows an example process flow of authentication, in some implementations, the process flow may include additional blocks, fewer blocks, different blocks, or differently arranged blocks from those depicted in FIG. 7. Additionally, or alternatively, some of the processes may be performed in parallel, or performed in a sequence different from the sequence listed in FIG. 7.

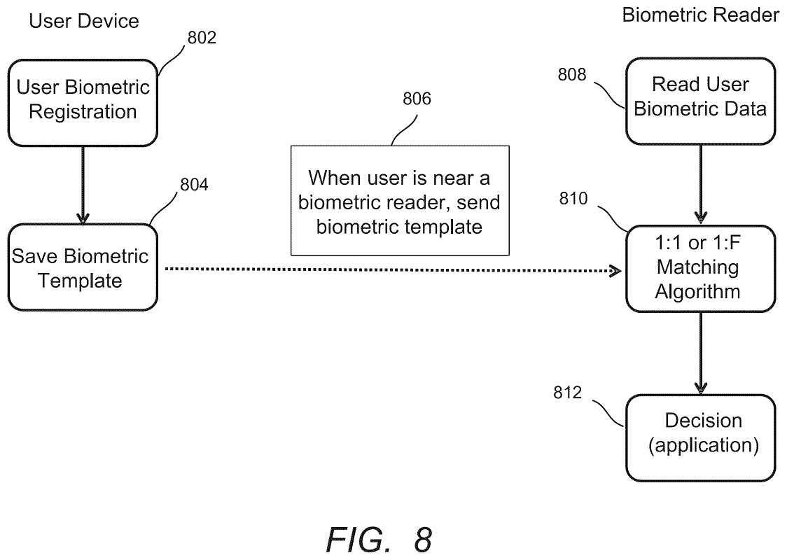

FIG. 8 illustrates an example of authentication, according to aspects of the disclosure. In the example illustrated in FIG. 8, the user may register his or her biometrics by performing a user biometric registration in block 802 at the user device, and save a biometric template in block 804 on the user device.

When the user device is near a biometric reader (e.g., a biometric reader in a merchant or POI terminal device), the user device may send the biometric template to a biometric reader, as shown in block 806. Upon receiving the biometric template, the biometric reader may read the biometric data of the user in block 808. The terminal device then may perform a 1:1 matching or 1:F matching by using a matching algorithm in block 810, and make a decision on whether to grant or deny a request by the user to access a secure service in block 812.

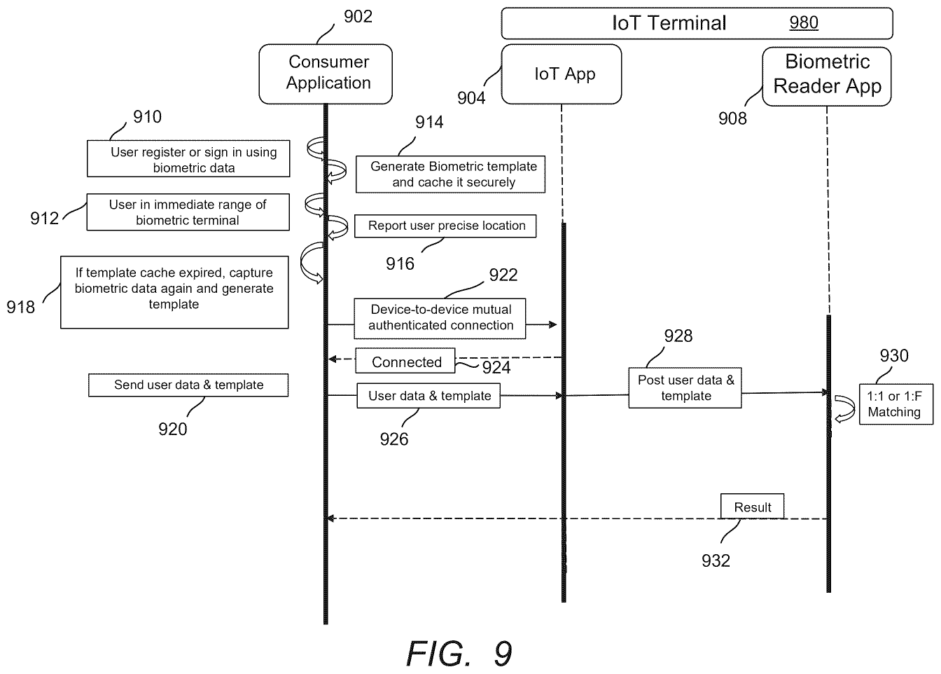

FIG. 9 illustrates an example authentication flow, according to aspects of the disclosure. In the example illustrated in FIG. 9, a consumer application 902 on a user device and an IoT application 904 and a biometric reader application 908 in an IoT terminal 980 are provided.

At stage 910, the user may register or sign in using his or her biometric data. At stage 912, the user may be in the immediate range or proximity of a biometric terminal, such as a terminal device with a biometric reader application 908. At stage 914, a biometric template may be generated and cached securely. At stage 916, the precise location of the user may be reported.

At stage 918, the biometric data may be captured and a template may be generated again if the template cache has expired. At stage 920, the consumer application 902 may send user data and template to the IoT application 904.

At stage 922, a device-to-device mutually authenticated connection may be established between the consumer application 902 and the IoT application 904. Once the IoT application 904 signals to the consumer application 902 that a connection has been established at stage 924, the consumer application 902 may send the user data and template to the IoT application 904 at stage 926.

At stage 928, the IoT application 904 may post the biometric templates to the biometric reader application 908. At stage 930, one-to-one (1:1) or one-to-few (1:F) matching may be performed. At stage 932, the result of the matching may be transmitted back to the consumer application 902.

Although FIG. 9 shows an example process flow of authentication, in some implementations, the process flow may include additional blocks, fewer blocks, different blocks, or differently arranged blocks from those depicted in FIG. 9. Additionally, or alternatively, some of the processes may be performed in parallel, or performed in a sequence different from the sequence listed in FIG. 9.

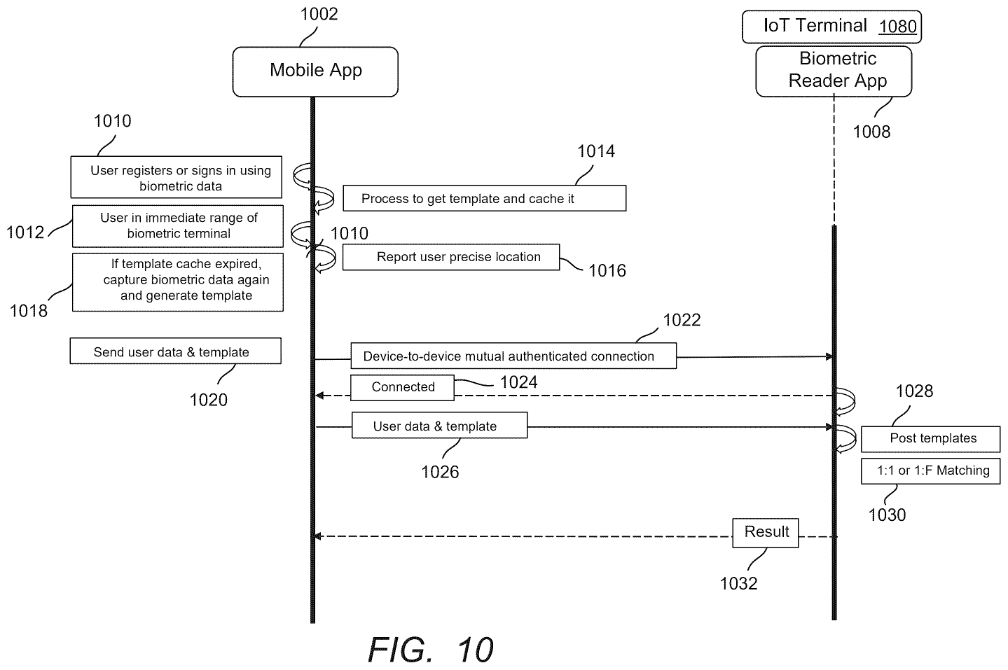

FIG. 10 illustrates an example authentication flow, according to aspects of the disclosure. In the example illustrated in FIG. 10, a mobile application 1002 on a user device and a biometric reader application 1008 in an IoT terminal 1080 are provided.

At stage 1010, the user may register or sign in using his or her biometric data. At stage 1012, the user may be in the immediate range or proximity of a terminal, such as a terminal device with a biometric reader application 1008. At stage 1014, the mobile application 1002 may process the biometric data to obtain a biometric template and cached it. At stage 1016, the mobile application 1002 may report the precise location of the user.

At stage 1018, the biometric data may be captured and a template may be generated again if the template cache has expired. At stage 1020, the mobile application 1002 may send user data and template to the biometric reader application 1008.

At stage 1022, a device-to-device mutually authenticated connection may be established between the mobile application 1002 and the biometric reader application 1008. Once the biometric reader application 1008 signals to the mobile application 1002 that a connection has been established at stage 1024, the mobile application 1002 may send the user data and template to the biometric reader application 1008 at stage 1026.

At stage 1028, the biometric reader application 1008 may post the biometric templates. At stage 1030, one-to-one (1:1) or one-to-few (1:F) matching may be performed. At stage 1032, the result of the matching may be transmitted back to the mobile application 1002.

Although FIG. 10 shows an example process flow of authentication, in some implementations, the process flow may include additional blocks, fewer blocks, different blocks, or differently arranged blocks from those depicted in FIG. 10. Additionally, or alternatively, some of the processes may be performed in parallel, or performed in a sequence different from the sequence listed in FIG. 10.

Examples above include a user in immediate range or near a biometric reader. In other examples, alternate and/or additional methodologies are used to enable 1:1 matching or 1:F matching instead of 1:M matching. For example, a store may limit or reduce a set of potential users/authenticators to customers who regularly check in at a particular location (or visit at a particular time) and/or who open the store's app or connect to the store's WiFi.

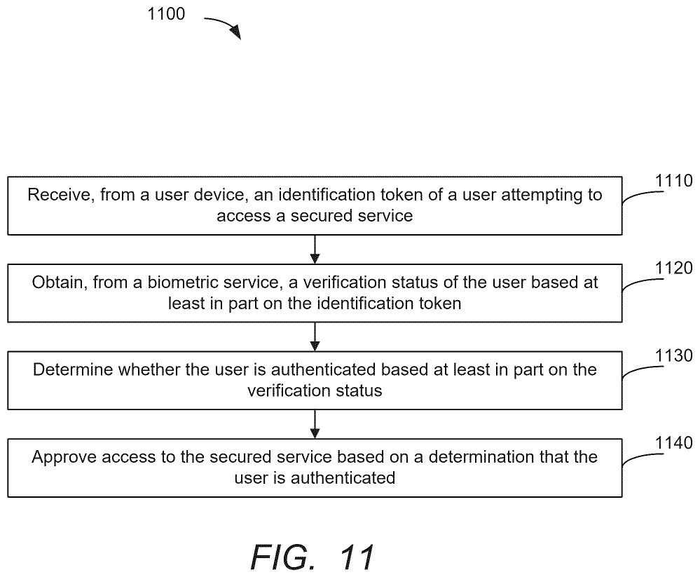

FIG. 11 illustrates an example method 1100 of authentication, according to aspects of the disclosure. In some aspects, method 1100 may be performed by authentication device (e.g., processing device 200 described herein).

At 1110, the authentication device may receive, from a user device, an identification token of a user attempting to access a secure service.

Means for performing the operation of block 1110 may include the processor(s), memory, or transceiver(s) of any of the processing device 200 described herein. For example, the operation of block 1110 may be performed by the one or more WWAN transceivers 210, the one or more short-range wireless transceivers 220, the one or more processors 242, memory 240, and/or authentication component 248, any or all of which may be considered means for performing this operation.

At 1120, the authentication device may obtain, from a biometric service, a verification status of the user based at least in part on the identification token.

Means for performing the operation of block 1120 may include the processor(s), memory, or transceiver(s) of any of the processing device 200 described herein. For example, the operation of block 1120 may be performed by the one or more WWAN transceivers 210, the one or more short-range wireless transceivers 220, the one or more processors 242, memory 240, and/or authentication component 248, any or all of which may be considered means for performing this operation.

At 1130, the authentication device may determine whether the user is authenticated based at least in part on the verification status.

Means for performing the operation of block 1130 may include the processor(s), memory, or transceiver(s) of any of the processing device 200 described herein. For example, the operation of block 1130 may be performed by the one or more WWAN transceivers 210, the one or more short-range wireless transceivers 220, the one or more processors 242, memory 240, and/or authentication component 248, any or all of which may be considered means for performing this operation.

At 1140, the authentication device may approve access to the secure service based on a determination that the user is authenticated.

Means for performing the operation of block 1140 may include the processor(s), memory, or transceiver(s) of any of the processing device 200 described herein. For example, the operation of block 1140 may be performed by the one or more WWAN transceivers 210, the one or more short-range wireless transceivers 220, the one or more processors 242, memory 240, and/or authentication component 248, any or all of which may be considered means for performing this operation.

Method 1100 may include additional implementations, such as any single implementation or any combination of implementations described below and/or in connection with one or more other processes described elsewhere herein.

In some aspects, the identification token comprises a biometric data template of the user, a user name of the user, one or more credentials of the user, or any combination thereof.

In some aspects, the biometric service comprises a biometric device, a biometric cloud, a biometric database, or any combination thereof.

In some aspects, method 1100 includes transmitting, to the biometric service, biometric data of the user based on the identification token.

In some aspects, method 1100 includes receiving, from at least one additional user device, at least one additional identification token of at least one additional user attempting to access the secure service, obtaining, from the biometric service, a verification status of the at least one additional user based at least in part on the at least one additional identification token, determining whether the at least one additional user is authenticated based at least in part on the verification status of the at least one additional user, and approving access, by the at least one additional user, to the secure service based on a determination that the at least one additional user is authenticated.

In some aspects, method 1100 includes receiving, from the biometric service, a plurality of potential identifications associated with a plurality of identification tokens including the identification token of the user.

In some aspects, method 1100 includes performing a one-to-multiple identification matching to select one of the potential identifications as an identification associated with the user.

In some aspects, performing the one-to-multiple identification matching comprises performing a one-to-few (1:F) identification matching to select the identification associated with the user from a number (F) of the potential identifications, where F is greater than one, determining whether the 1:F identification matching is successful, and performing a one-to-many (1:M) identification matching to select the identification associated with the user from a number (M) of the potential identifications, where M is greater than F, based on a determination that the 1:F identification matching is not successful.

In some aspects, performing the 1:M identification matching comprises selecting the identification associated with the user based at least in part on user device metadata including an identification of the user device, a location of the user device, a time of communication by the user device, or any combination thereof.

In some aspects, the secure service is a banking service, a sales service, a government service, an employment service, or any combination thereof.

In some aspects, the identification token is received from the user device via A BLUETOOTH® communication link, a BLUETOOTH® Low Energy (BLE) communication link, an ultra-wideband (UWB) communication link, a wireless local area network (WLAN) communication link, or a wireless wide area network (WWAN) communication link.

Although FIG. 11 shows example blocks of method 1100, in some implementations, method 1100 may include additional blocks, fewer blocks, different blocks, or differently arranged blocks from those depicted in FIG. 11. Additionally, or alternatively, two or more of the blocks of method 1100 may be performed in parallel, or performed in a sequence different from the sequence listed in FIG. 11.

As will be appreciated, a technical advantage of the method 1100 is that, by performing authentication operations for one or more users at authentication device, the described techniques can be used to enhance the efficiency and reduce the latency of authentication operations while improving user experience.

Another technical advantage of the method 1100 is that, whereas some existing biometric solutions may require users to provide their user ID, driver's license, and/or another form of identity before the actual biometric matching may take place, which may cause friction in some instances, by performing the method according to aspects of the disclosure, user credentials and device details may be seamlessly passed to a biometric device without requiring any manual action from the user. The data passed may be used as the first factor of authentication to identify the user whereas the actual biometrics may serve as the second factor of authentication, thus reducing the likelihood of friction associated with the first factor of authentication.

Another technical advantage of the method 1100 is that, in some implementations, where the user's template is sent to an IoT terminal, it may not be necessary for the IoT terminal to capture the user's biometrics again to generate a template. In some implementations, the template received from the user device may be directly matched by the biometric service against the biometric database to help maintain user privacy. For example, in some implementations, the image or audio captured to generate the biometric template may remain on the user device, and only the encrypted template may be transferred to the IoT terminal.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of authentication performed at an authentication device, comprising: receiving, from a user device, an identification token of a user attempting to access a secure service; obtaining, from a biometric service, a verification status of the user based at least in part on the identification token; determining whether the user is authenticated based at least in part on the verification status; and approving access to the secure service based on a determination that the user is authenticated.
Clause 2. The method of clause 1, wherein the identification token comprises: a biometric data template of the user; a user name of the user; one or more credentials of the user; a location of the user; a behavior pattern of the user; or any combination thereof.
Clause 3. The method of any of clauses 1 to 2, wherein the biometric service comprises: a biometric device; a biometric cloud; a biometric database; or any combination thereof.
Clause 4. The method of any of clauses 1 to 3, further comprising: transmitting, to the biometric service, biometric data, location data, or any combination thereof, of the user based on the identification token.
Clause 5. The method of any of clauses 1 to 4, further comprising: receiving, from at least one additional user device, at least one additional identification token of at least one additional user attempting to access the secure service; obtaining, from the biometric service, a verification status of the at least one additional user based at least in part on the at least one additional identification token; determining whether the at least one additional user is authenticated based at least in part on the verification status of the at least one additional user; and approving access, by the at least one additional user, to the secure service based on a determination that the at least one additional user is authenticated.
Clause 6. The method of any of clauses 1 to 5, further comprising: performing a one-to-one matching of a biometric data template.
Clause 7. The method of any of clauses 1 to 6, further comprising: receiving, from the biometric service, a plurality of potential identifications associated with a plurality of identification tokens including the identification token of the user.
Clause 8. The method of clause 7, further comprising: performing a one-to-multiple identification matching to select one of the potential identifications as an identification associated with the user.
Clause 9. The method of clause 8, wherein performing the one-to-multiple identification matching comprises: performing a one-to-few (1:F) identification matching to select the identification associated with the user from a number (F) of the potential identifications, where F is greater than one.
Clause 10. The method of clause 9, wherein performing the 1:F identification matching comprises: selecting the identification associated with the user based at least in part on user device metadata including an identification of the user device, a location of the user device, a time of communication by the user device, or any combination thereof.
Clause 11. The method of any of clauses 9 to 10, wherein performing the one-to-multiple identification matching further comprises: determining whether the 1:F identification matching is successful; and performing a one-to-many (1:M) identification matching to select the identification associated with the user from a number (M) of the potential identifications, where M is greater than F, based on a determination that the 1:F identification matching is not successful.
Clause 12. The method of clause 11, wherein performing the 1:M identification matching comprises: selecting the identification associated with the user based at least in part on user device metadata including an identification of the user device, a location of the user device, a time of communication by the user device, or any combination thereof.
Clause 13. The method of any of clauses 1 to 12, wherein the secure service is: a banking service; a sales service; a government service; an employment service; or any combination thereof.
Clause 14. The method of any of clauses 1 to 13, wherein the identification token is received from the user device via: a BLUETOOTH® communication link; a BLUETOOTH® Low Energy (BLE) communication link; an ultra-wideband (UWB) communication link; a wireless local area network (WLAN) communication link; a wireless wide area network (WWAN) communication link; or a communication sidelink.
Clause 15. An authentication device, comprising: one or more memories; one or more transceivers; and one or more processors communicatively coupled to the one or more memories and the one or more transceivers, the one or more processors, either alone or in combination, configured to: receive, via the one or more transceivers, from a user device, an identification token of a user attempting to access a secure service; obtain, from a biometric service, a verification status of the user based at least in part on the identification token; determine whether the user is authenticated based at least in part on the verification status; and approve access to the secure service based on a determination that the user is authenticated.
Clause 16. The authentication device of clause 15, wherein the identification token comprises: a biometric data template of the user; a user name of the user; one or more credentials of the user; a location of the user; a behavior pattern of the user; or any combination thereof.
Clause 17. The authentication device of any of clauses 15 to 16, wherein the biometric service comprises: a biometric device; a biometric cloud; a biometric database; or any combination thereof.
Clause 18. The authentication device of any of clauses 15 to 17, wherein the one or more processors, either alone or in combination, are further configured to: transmit, via the one or more transceivers, to the biometric service, biometric data, location data, or any combination thereof, of the user based on the identification token.
Clause 19. The authentication device of any of clauses 15 to 18, wherein the one or more processors, either alone or in combination, are further configured to: receive, via the one or more transceivers, from at least one additional user device, at least one additional identification token of at least one additional user attempting to access the secure service; obtain, from the biometric service, a verification status of the at least one additional user based at least in part on the at least one additional identification token; determine whether the at least one additional user is authenticated based at least in part on the verification status of the at least one additional user; and approve access to the secure service based on a determination that the at least one additional user is authenticated.
Clause 20. The authentication device of any of clauses 15 to 19, wherein the one or more processors, either alone or in combination, are further configured to: perform a one-to-one matching of a biometric data template.
Clause 21. The authentication device of any of clauses 15 to 20, wherein the one or more processors, either alone or in combination, are further configured to: receive, via the one or more transceivers, from the biometric service, a plurality of potential identifications associated with a plurality of identification tokens including the identification token of the user.
Clause 22. The authentication device of clause 21, wherein the one or more processors, either alone or in combination, are further configured to: perform a one-to-multiple identification matching to select one of the potential identifications as an identification associated with the user.
Clause 23. The authentication device of clause 22, wherein the one or more processors configured to perform the one-to-multiple identification matching comprise the one or more processors, either alone or in combination, configured to: perform a one-to-few (1:F) identification matching to select the identification associated with the user from a number (F) of the potential identifications, where F is greater than one.
Clause 24. The authentication device of clause 23, wherein the one or more processors configured to perform the 1:F identification matching comprise the one or more processors, either alone or in combination, configured to: select the identification associated with the user based at least in part on user device metadata including an identification of the user device, a location of the user device, a time of communication by the user device, or any combination thereof.
Clause 25. The authentication device of any of clauses 23 to 24, wherein the one or more processors configured to perform the one-to-multiple identification matching further comprise the one or more processors, either alone or in combination, configured to: determine whether the 1:F identification matching is successful; and perform a one-to-many (1:M) identification matching to select the identification associated with the user from a number (M) of the potential identifications, where M is greater than F, based on a determination that the 1:F identification matching is not successful.
Clause 26. The authentication device of clause 25, wherein the one or more processors configured to perform the 1:M identification matching comprise the one or more processors, either alone or in combination, configured to: select the identification associated with the user based at least in part on user device metadata including an identification of the user device, a location of the user device, a time of communication by the user device, or any combination thereof.
Clause 27. The authentication device of any of clauses 15 to 26, wherein the secure service is: a banking service; a sales service; a government service; an employment service; or any combination thereof.
Clause 28. The authentication device of any of clauses 15 to 27, wherein the identification token is received from the user device via: a BLUETOOTH® communication link; a BLUETOOTH® Low Energy (BLE) communication link; an ultra-wideband (UWB) communication link; a wireless local area network (WLAN) communication link; a wireless wide area network (WWAN) communication link; or a communication sidelink.
Clause 29. An authentication device, comprising: means for receiving, from a user device, an identification token of a user attempting to access a secure service; means for obtaining, from a biometric service, a verification status of the user based at least in part on the identification token; means for determining whether the user is authenticated based at least in part on the verification status; and means for approving access to the secure service based on a determination that the user is authenticated.
Clause 30. The authentication device of clause 29, wherein the identification token comprises: a biometric data template of the user; a user name of the user; one or more credentials of the user; a location of the user; a behavior pattern of the user; or any combination thereof.
Clause 31. The authentication device of any of clauses 29 to 30, wherein the biometric service comprises: a biometric device; a biometric cloud; a biometric database; or any combination thereof.
Clause 32. The authentication device of any of clauses 29 to 31, further comprising: means for transmitting, to the biometric service, biometric data, location data, or any combination thereof, of the user based on the identification token.
Clause 33. The authentication device of any of clauses 29 to 32, further comprising: means for receiving, from at least one additional user device, at least one additional identification token of at least one additional user attempting to access the secure service; means for obtaining, from the biometric service, a verification status of the at least one additional user based at least in part on the at least one additional identification token; means for determining whether the at least one additional user is authenticated based at least in part on the verification status of the at least one additional user; and means for approving access to the secure service based on a determination that the at least one additional user is authenticated.
Clause 34. The authentication device of any of clauses 29 to 33, further comprising: means for performing a one-to-one matching of a biometric data template.
Clause 35. The authentication device of any of clauses 29 to 34, further comprising: means for receiving, from the biometric service, a plurality of potential identifications associated with a plurality of identification tokens including the identification token of the user.
Clause 36. The authentication device of clause 35, further comprising: means for performing a one-to-multiple identification matching to select one of the potential identifications as an identification associated with the user.
Clause 37. The authentication device of clause 36, wherein the means for performing the one-to-multiple identification matching comprises: means for performing a one-to-few (1:F) identification matching to select the identification associated with the user from a number (F) of the potential identifications, where F is greater than one.
Clause 38. The authentication device of clause 37, wherein the means for performing the 1:F identification matching comprises: means for selecting the identification associated with the user based at least in part on user device metadata including an identification of the user device, a location of the user device, a time of communication by the user device, or any combination thereof.
Clause 39. The authentication device of any of clauses 37 to 38, wherein the means for performing the one-to-multiple identification matching further comprises: means for determining whether the 1:F identification matching is successful; and means for performing a one-to-many (1:M) identification matching to select the identification associated with the user from a number (M) of the potential identifications, where M is greater than F, based on a determination that the 1:F identification matching is not successful.
Clause 40. The authentication device of clause 39, wherein the means for performing the 1:M identification matching comprises: means for selecting the identification associated with the user based at least in part on user device metadata including an identification of the user device, a location of the user device, a time of communication by the user device, or any combination thereof.
Clause 41. The authentication device of any of clauses 29 to 40, wherein the secure service is: a banking service; a sales service; a government service; an employment service; or any combination thereof.
Clause 42. The authentication device of any of clauses 29 to 41, wherein the identification token is received from the user device via: a BLUETOOTH® communication link; a BLUETOOTH® Low Energy (BLE) communication link; an ultra-wideband (UWB) communication link; a wireless local area network (WLAN) communication link; a wireless wide area network (WWAN) communication link; or a communication sidelink.
Clause 43. A non-transitory computer-readable medium stores computer-executable instructions that, when executed by an authentication device, cause the authentication device to: receive, from a user device, an identification token of a user attempting to access a secure service; obtain, from a biometric service, a verification status of the user based at least in part on the identification token; determine whether the user is authenticated based at least in part on the verification status; and approve access to the secure service based on a determination that the user is authenticated.
Clause 44. The non-transitory computer-readable medium of clause 43, wherein the identification token comprises: a biometric data template of the user; a user name of the user; one or more credentials of the user; a location of the user; a behavior pattern of the user; or any combination thereof.
Clause 45. The non-transitory computer-readable medium of any of clauses 43 to 44, wherein the biometric service comprises: a biometric device; a biometric cloud; a biometric database; or any combination thereof.
Clause 46. The non-transitory computer-readable medium of any of clauses 43 to 45, further comprising computer-executable instructions that, when executed by the authentication device, cause the authentication device to: transmit, to the biometric service, biometric data, location data, or any combination thereof, of the user based on the identification token.
Clause 47. The non-transitory computer-readable medium of any of clauses 43 to 46, further comprising computer-executable instructions that, when executed by the authentication device, cause the authentication device to: receive, from at least one additional user device, at least one additional identification token of at least one additional user attempting to access the secure service; obtain, from the biometric service, a verification status of the at least one additional user based at least in part on the at least one additional identification token; determine whether the at least one additional user is authenticated based at least in part on the verification status of the at least one additional user; and approve access to the secure service based on a determination that the at least one additional user is authenticated.
Clause 48. The non-transitory computer-readable medium of any of clauses 43 to 47, further comprising computer-executable instructions that, when executed by the authentication device, cause the authentication device to: perform a one-to-one matching of a biometric data template.
Clause 49. The non-transitory computer-readable medium of any of clauses 43 to 48, further comprising computer-executable instructions that, when executed by the authentication device, cause the authentication device to: receive, from the biometric service, a plurality of potential identifications associated with a plurality of identification tokens including the identification token of the user.
Clause 50. The non-transitory computer-readable medium of clause 49, further comprising computer-executable instructions that, when executed by the authentication device, cause the authentication device to: perform a one-to-multiple identification matching to select one of the potential identifications as an identification associated with the user.
Clause 51. The non-transitory computer-readable medium of clause 50, wherein the computer-executable instructions that, when executed by the authentication device, cause the authentication device to perform the one-to-multiple identification matching comprise computer-executable instructions that, when executed by the authentication device, cause the authentication device to: perform a one-to-few (1:F) identification matching to select the identification associated with the user from a number (F) of the potential identifications, where F is greater than one.
Clause 52. The non-transitory computer-readable medium of clause 51, wherein the computer-executable instructions that, when executed by the authentication device, cause the authentication device to perform the 1:F identification matching comprise computer-executable instructions that, when executed by the authentication device, cause the authentication device to: select the identification associated with the user based at least in part on user device metadata including an identification of the user device, a location of the user device, a time of communication by the user device, or any combination thereof.
Clause 53. The non-transitory computer-readable medium of any of clauses 51 to 52, wherein the computer-executable instructions that, when executed by the authentication device, cause the authentication device to perform the one-to-multiple identification matching further comprise computer-executable instructions that, when executed by the authentication device, cause the authentication device to: determine whether the 1:F identification matching is successful; and perform a one-to-many (1:M) identification matching to select the identification associated with the user from a number (M) of the potential identifications, where M is greater than F, based on a determination that the 1:F identification matching is not successful.
Clause 54. The non-transitory computer-readable medium of clause 53, wherein the computer-executable instructions that, when executed by the authentication device, cause the authentication device to perform the 1:M identification matching comprise computer-executable instructions that, when executed by the authentication device, cause the authentication device to: select the identification associated with the user based at least in part on user device metadata including an identification of the user device, a location of the user device, a time of communication by the user device, or any combination thereof.
Clause 55. The non-transitory computer-readable medium of any of clauses 43 to 54, wherein the secure service is: a banking service; a sales service; a government service; an employment service; or any combination thereof.
Clause 56. The non-transitory computer-readable medium of any of clauses 43 to 55, wherein the identification token is received from the user device via: a BLUETOOTH® communication link; a BLUETOOTH® Low Energy (BLE) communication link; an ultra-wideband (UWB) communication link; a wireless local area network (WLAN) communication link; a wireless wide area network (WWAN) communication link; or a communication sidelink.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An authentication device, comprising:
one or more memories;
one or more transceivers; and
one or more processors communicatively coupled to the one or more memories and the one or more transceivers, the one or more processors, either alone or in combination, configured to:
receive, via the one or more transceivers, from a user device, an identification token of a user attempting to access a secure service;
obtain, from a biometric service, a verification status of the user based at least in part on the identification token;
determine whether the user is authenticated based at least in part on the verification status; and
approve access to the secure service based on a determination that the user is authenticated.

2. The authentication device of claim 1, wherein the identification token comprises:
a biometric data template of the user;
a user name of the user;
one or more credentials of the user;
a location of the user;
a behavior pattern of the user;
or any combination thereof.

3. The authentication device of claim 1, wherein the biometric service comprises:
a biometric device;
a biometric cloud;
a biometric database;
or any combination thereof.

4. The authentication device of claim 1, wherein the one or more processors, either alone or in combination, are further configured to:
transmit, via the one or more transceivers, to the biometric service, biometric data, location data, or any combination thereof, of the user based on the identification token.

5. The authentication device of claim 1, wherein the one or more processors, either alone or in combination, are further configured to:
receive, via the one or more transceivers, from at least one additional user device, at least one additional identification token of at least one additional user attempting to access the secure service;
obtain, from the biometric service, a verification status of the at least one additional user based at least in part on the at least one additional identification token;
determine whether the at least one additional user is authenticated based at least in part on the verification status of the at least one additional user; and
approve access to the secure service based on a determination that the at least one additional user is authenticated.

6. The authentication device of claim 1, wherein the one or more processors, either alone or in combination, are further configured to:
perform a one-to-one matching of a biometric data template.

7. The authentication device of claim 1, wherein the one or more processors, either alone or in combination, are further configured to:
receive, via the one or more transceivers, from the biometric service, a plurality of potential identifications associated with a plurality of identification tokens including the identification token of the user.

8. The authentication device of claim 7, wherein the one or more processors, either alone or in combination, are further configured to:
perform a one-to-multiple identification matching to select one of the potential identifications as an identification associated with the user.

9. The authentication device of claim 8, wherein the one or more processors configured to perform the one-to-multiple identification matching comprise the one or more processors, either alone or in combination, configured to:
perform a one-to-few (1:F) identification matching to select the identification associated with the user from a number (F) of the potential identifications, where F is greater than one.

10. The authentication device of claim 9, wherein the one or more processors configured to perform the 1:F identification matching comprise the one or more processors, either alone or in combination, configured to:
select the identification associated with the user based at least in part on user device metadata including an identification of the user device, a location of the user device, a time of communication by the user device, or any combination thereof.

11. The authentication device of claim 9, wherein the one or more processors configured to perform the one-to-multiple identification matching further comprise the one or more processors, either alone or in combination, configured to:
determine whether the 1:F identification matching is successful; and
perform a one-to-many (1:M) identification matching to select the identification associated with the user from a number (M) of the potential identifications, where M is greater than F, based on a determination that the 1:F identification matching is not successful.

12. The authentication device of claim 11, wherein the one or more processors configured to perform the 1:M identification matching comprise the one or more processors, either alone or in combination, configured to:
select the identification associated with the user based at least in part on user device metadata including an identification of the user device, a location of the user device, a time of communication by the user device, or any combination thereof.

13. The authentication device of claim 1, wherein the secure service is:
a banking service;
a sales service;
a government service;
an employment service;
or any combination thereof.

14. The authentication device of claim 1, wherein the identification token is received from the user device via:
a BLUETOOTH® communication link;
a BLUETOOTH® Low Energy (BLE) communication link;
an ultra-wideband (UWB) communication link;
a wireless local area network (WLAN) communication link;
a wireless wide area network (WWAN) communication link; or
a communication sidelink.

15. A method of authentication performed at an authentication device, comprising:
receiving, from a user device, an identification token of a user attempting to access a secure service;
obtaining, from a biometric service, a verification status of the user based at least in part on the identification token;
determining whether the user is authenticated based at least in part on the verification status; and
approving access to the secure service based on a determination that the user is authenticated.

16. The method of claim 15, wherein the identification token comprises:
a biometric data template of the user;
a user name of the user;
one or more credentials of the user;
a location of the user;
a behavior pattern of the user;
or any combination thereof.

17. The method of claim 15, wherein the biometric service comprises:
a biometric device;
a biometric cloud;
a biometric database;
or any combination thereof.

18. A non-transitory computer-readable medium storing computer-executable instructions that, when executed by an authentication device, cause the authentication device to:
receive, from a user device, an identification token of a user attempting to access a secure service;
obtain, from a biometric service, a verification status of the user based at least in part on the identification token;
determine whether the user is authenticated based at least in part on the verification status; and
approve access to the secure service based on a determination that the user is authenticated.

19. The non-transitory computer-readable medium of claim 18, wherein the identification token comprises:
a biometric data template of the user;
a user name of the user;
one or more credentials of the user;
a location of the user;
a behavior pattern of the user;
or any combination thereof.

20. The non-transitory computer-readable medium of claim 18, wherein the biometric service comprises:
a biometric device;
a biometric cloud;
a biometric database;
or any combination thereof.
